(19) United States
(12) Patent Application Publication
(10) Pub. No.: US 2016/0283898 A1
(43) Pub. Date: Sep. 29, 2016

(54) INVENTORY MANAGEMENT SYSTEM

(71) Applicant: ADOLF WÜRTH GMBH & CO. KG, Künzelsau (DE)

(72) Inventors: Herbert REUTHER, Krautheim (DE); Dirk VOLLMER, Kupferzell (DE); Wolfgang HOHL, Künzelsau (DE); Oliver OBERNDÖRFER, Hardthausen (DE); Simon KOCH, Dörzbach (DE)

(21) Appl. No.: 15/033,538

(22) PCT Filed: Oct. 30, 2014
(86) PCT No.: PCT/EP2014/073365

§ 371 Date: Apr. 29, 2016

(30) Foreign Application Priority Data
Oct. 31, 2013 (DE) 10 2013 222 263.7

(51) Int. Cl. G06Q 10/08

(52) U.S. Cl. CPC G06Q 10/087

(57) ABSTRACT

Inventory management system having a plurality of filling devices, which are to be filled with merchandise elements, a plurality of merchandise elements in and/or at the filling devices, detector devices, which are assigned to the filling devices and/or merchandise elements, and which are for detecting sensor data that are indicative of a fill state of at least some of the filling devices with the merchandise elements, and a control device that is configured to determine a current stock of at least some of the filling devices and/or of at least some of the merchandise elements, particularly in and/or at the filling devices, on the basis of the sensor data.

### CROSS-REFERENCE TO RELATED APPLICATIONS

This patent application is a National Phase Patent Application and claims priority to and the benefit of International Application Number PCT/EP2014/073365, filed Oct. 30, 2014, which claims priority to and the benefit of German Patent Application Number 10 2013 222 263.7, filed Oct. 31, 2013, the entire disclosures of which are hereby incorporated herein by reference.

### FIELD OF THE INVENTION

The invention relates to an inventory management system, a method for managing an inventory, a computer-readable storage medium and a software program.

### TECHNOLOGICAL BACKGROUND

The logistic handling of large stocks of merchandise conventionally poses a challenge in particular in cases, when the quantity of goods is large, the kinds of goods are strongly diversified, the goods (or merchandise) and the goods in stock are subject to a frequent change, and the particular stock locations of the goods are spatially far from each other respectively also the stock locations change frequently.

Such goods in a stock are conventionally managed in a computer-assisted way. Persons check decentrally the goods in stock and re-order goods locally as and when required. This method is slow, time-consuming, labour-intensive and requires many decentralized resources due to the local processing of individual goods in stock.

### SUMMARY OF THE INVENTION

There may be a need to provide an inventory management system that is conserving resources and optionally substantially able to work in real-time.

According to an exemplary embodiment of the present invention, an inventory management system is accomplished, which comprises: a plurality of filling devices (or loading devices), which are to be filled with merchandise elements (or product elements), a plurality of merchandise elements in and/or at the filling devices, detector devices assigned to the filling devices and/or merchandise elements (particularly detector devices provided at the filling devices and/or merchandise elements) for detecting sensor data, which are indicative for a fill state of at least some of the filling devices with the merchandise elements, and a control device, which is configured to determine (or ascertain) a current stock of at least some of the filling devices and/or of at least some of the merchandise elements, particularly in and/or at the filling devices, based on the sensor data.

According to a further exemplary embodiment of the present invention, a method for managing an inventory in a plurality of filling devices, which are filled with and/or to be filled with merchandise elements, is provided, wherein according to the method, sensor data, which are indicative for a fill state of at least some of the filling devices with the merchandise elements, are detected by means of detector devices assigned to the filling devices and/or to merchandise elements (particularly detector devices that are conceived respectively mounted to the filling devices and/or merchandise elements), and a current stock of at least some of the filling devices and/or of at least some of the merchandise elements, particularly in and/or at the filling devices, is determined (or ascertained) on the basis of the sensor data.

In a computer-readable storage medium according to an exemplary S embodiment of the present invention, a program for managing an inventory in a plurality of filling devices, which are filled and/or to be filled with merchandise elements, is stored, which program comprises respectively executes the method steps described above, if the program is executed by one or a plurality of processors.

A software program (for example formed by one or a plurality of computer program elements) according to an exemplary embodiment of the present invention for managing an inventory in a plurality of filling devices, which are filled and/or to be filled with merchandise elements, comprises the method steps described above (respectively performs these or controls these), if the program is executed by one or a plurality of processors of the control device.

More detailed exemplary embodiments of the present invention may be realized both by means of a computer program, i.e. a software, and by means of one or a plurality of particular electronic circuits, i.e. in hardware, or in an arbitrary hybrid form, i.e. by means of software components and hardware components.

In the context of the present application the term “inventory management system” is understood to be, in particular, an automated and preferably network-assisted arrangement of entities respectively nodes, which are coupled or couplable capably-for-communication with each other, which arrangement is capable to measure qualitatively and/or quantitatively a stock of merchandise elements that are present and/or a fill quantity of filling devices, at a particular point in time, preferably without interposition of an operator. Such an inventory management system can, as the case may be, make accessible the measured stock and/or information derived therefrom downstream to an operator and/or trigger automatically an event on the basis of the result of the measurement.

In the context of the present application, the term “merchandise element” (or product element) is understood to be, in particular, a manageable respectively tradable physical body, which forms, together with many other merchandise elements, the stock which is subject to a continuous change. Examples for such merchandise elements are in particular technical devices or components, such as for example tool components (for example hammer, screwdriver, etc.)

or consumable components (for example screws, nails, anchor fittings, etc.). In the framework of an exemplary embodiment, a stock of such merchandise elements may be subject to the change, in particular in respect of the quantity of the merchandise elements in individual or all filling devices and/or also the kind respectively the type of the merchandise elements. This means that new merchandise elements (such as those at hand or those not yet at hand) may be added to the stock, and/or merchandise elements that are present may be removed from the stock. Examples for the kind respectively type of the merchandise elements are: the contents of cases, the components of machines, the contents of a case for a machine, inlays for tools, canisters, cans, bottles, cartridges, tubes and/or contents of drawers.

In the context of the present application, the term “filling device” (or filling device) is understood to be, in particular, a receiving device, in and/or at which merchandise elements are received or can be received normally (or according to intended use). A respective filling device and merchandise elements respectively assigned or appendant to the former may be adapted to one another, particularly in respect of dimension and/or shape. Due to such a specific adaptation between a merchandise element and an assigned filling device, a well-defined number of allocation spaces may be assigned to a particular filling device, each of which spaces is configured to receive one or a specified quantity of merchandise elements of the predetermined type. It is possible that a filling device is configured to receive only a specific type of merchandise elements (for example, in the case that the filling device has similar compartments, each of which is shaped and dimensioned such that for example only a very specifically shaped and dimensioned merchandise packaging or merchandise as such can be accommodated in the respective compartment). However, it is also possible that a filling device is configured to receive different types of merchandise elements (for example when the filling device has different types of compartment, each of which types is shaped and dimensioned such that for example a very specifically shaped and dimensioned merchandise packaging as such can be accommodated in the respective compartment of the respective type). An example for this is a tool box having pre-shaped and differently dimensioned and/or shaped receiving recesses for receiving particular tools.

In the context of the present application, the term “detector device” is understood to be, in particular, a device for measuring (or capturing) the presence or absence and/or the fill level of one or a plurality of merchandise elements in and/or at a particular filling device, or in and/or at a particular compartment of a particular filling device. Thereby, the detector device may be connected physically with a merchandise element and/or with a filling device or, alternatively, may be embodied as a component that is physically separated from the merchandise element respectively the filling device but which is in a sensorily effective (or operative) relation with a filling device and/or a merchandise element. The detector device may be configured to measure at least one parameter, which is indicative for the presence or absence of one or a plurality of merchandise elements in an assigned filling device. Thereby, the determined sensor information may comprise qualitative data (for example merchandise is present: yes/no) or quantitative data (number of merchandise elements at and/or in a particular filling device or a fill level). Such a detector device can be configured to measure measurement data (for example a weight of merchandise elements with and/or without a filling device). As the case may be, the detector device may also draw a final conclusion from the measurement data, for example by means of processing the measurement data, for example the determining of a quantity of merchandise elements (for example the determining of a number (for example number of screws in a carton) or an amount (or quantity) (for example volume of a liquid in a container) of merchandise elements).

In the context of the present application, the term “sensor data” is understood to be, in particular, machine-evaluable data, which can be transmitted along a communication path between the detector device and the control device. This transmission may occur wire-connectedly or wirelessly. For example, the data may be transmitted as electrical signals or optical signals or high frequency signals.

In the context of the present application, the term “control device” is understood to be, in particular, a device having processor resources, which is configured to process—in particular by programming means—the provided sensor data, based on given algorithms, and to determine an output information that reflects the present stock, based on this processing of the sensor data. During this processing, the processor resource may be coupled uni-directionally or preferably bi-directionally capably-for-communication with a data storage resource of the control device, so as to access data therefrom and/or to store data therein. The control device may be embodied for example as a computer respectively processor or as a plurality of co-operating computers or processors (which may be located spatially proximate or spatially separated from each other).

### MORE DETAILED EXEMPLARY EMBODIMENTS

According to an exemplary embodiment, filling devices for receiving merchandise elements and/or the merchandise elements themselves may continuously be monitored sensorily (or by means of a sensor). The sensorily measured stocks of the merchandise elements at the respective filling devices ti may then be transmitted to a central control device, which measures the information of the individual decentralized detector devices virtually in real-time and strongly robustly against errors, and evaluates this information such that the stock, i.e. the total amount and the local distribution of the individual merchandise elements over the associated filling devices respectively also the spatial distribution and occupation of the individual filling devices, can be determined and provided respectively further processed centrally. By such an architecture consisting of detector devices that are mounted locally at the filling devices and/or merchandise [elements] as well as a central processor respectively storage resource in the form of the control device, an overview over the current stock of merchandise elements and filling devices may be obtained quickly, robustly against errors and with little effort, and the stock may be managed respectively updated accordingly.

Additional exemplary embodiments of the inventory management system, of the method, of the computer-readable storage medium and of the software program are described in the following.

According to an exemplary embodiment, the filling devices may be selected from a group, which consists of: a goods shelf, a goods cupboard (or closet), a goods drawer, a canister, a container for bulk goods (or loose material), a goods box, a delivery vehicle, an assembly line, a tool trolley, a mobile workshop (or a tool and gear wagon), a workbench and a tool case. Even a secondary inventory (or warehouse) or a particular subsidiary (for example of an enterprise or of a sales and distribution network) may be managed (or handled) as a filling device. Thus, very different types of filling devices may be accounted for according to the invention. This applies both to filling devices, which are located on a fixed location, for example fixedly installed goods shelves, and to filling devices, which are subjected to continuous changes of location according to intended use, such as for example tool trolleys, goods cases of field workers, etc. The individual filling devices may be autonomously operative, i.e. operated independently from other filling devices respectively merchandise elements and thus employed in arbitrary combination with other filling devices and/or merchandise elements. In this case, only a communication between the control device and the filling devices is required, in order to integrate filling devices in the inventory management system independently from location and stock. In particular, it is possible that filling devices and the control device recognize each other automatically, in order to integrate a filling device in the inventory management system.

According to an exemplary embodiment, the merchandise elements may be selected from a group, which consists of: not packed merchandise elements, packed merchandise elements, bulk goods (or loose material), fluid, a canister, a case (or packing case), a box, an equipment of a mobile workshop, an equipment of a workbench, a tool set, an equipment of a vehicle and an equipment of consumer products (or consumables). Merchandise elements in stocks of merchandise or at other locations of the inventory management system are naturally subjected to a continuous change of location, for example due to a disposition to a client, consumption and transfer to a mounting site. The merchandise elements may be configured capably-for-communication with associated filling devices and/or capably-for-communication with the control device, such that their stock can be monitored continuously.

According to an exemplary embodiment, the detector devices may be selected from a group, which consists of: at least one optical measuring device for measuring optical data of at least one merchandise element and/or of compartments of a respective filling device, which compartments are to be filled with one or a plurality of merchandise elements; a weight measuring device for measuring a weight of at least one merchandise element and/or in a compartment of a respective filling device, which compartment is to be filled with one or a plurality of merchandise elements; an electrical sensor for measuring an electrical indicator (or measurand), which indicator depends on the fill state, of at least one merchandise element and/or in a compartment of a respective filling device, which compartment is to be filled with one or a plurality of merchandise elements; a pressure measuring device for measuring a pressure of at least one merchandise element and/or in a compartment of a respective filling device, which compartment is to be filled with one or a plurality of merchandise elements; a scanner for measuring scan data of one or a plurality of merchandise elements located in a respective filling device; and a combination consisting of a transponder, particularly an RFID tag, at a respective merchandise element and an associated transponder reading device on an associated filling device. An optical measuring device may for example be a camera, which records an image of a filling device and which searches the recorded image for merchandise elements received in the filling device for example by using methods of image recognition. The optical measuring device may however also be a photoelectric barrier, which may be provided at a filling device at each spot (or location) of a possible storing of a merchandise element and which may measure the presence respectively absence of a merchandise element at each of these spots, based on a signal from the photoelectric barrier. Such an optical measuring device may also be embodied as a (particularly one-dimensional or two-dimensional) bar code scanner or the like which is capable to trace and identify by means of scanning the merchandise elements that are stored on a filling device. A weight measuring device may be provided, according to an embodiment, for example at the bottom of a container for bulk goods, in order to determine the weight of the bulk goods and to determine the number of the merchandise elements, which are currently present in the respective filling device, with knowledge of the weight respectively the average weight of a bulk goods element. Alternatively, the weight measuring device may also be a weighing device which determines at individual compartments respectively receiving spaces of a filling device in a space-resolved way, whether a respective compartment is occupied with a merchandise element or not. Even the occupation with a correct, i.e. expected, merchandise element with a known weight can thus be determined in a space-resolved way. For example, such a weight measurement may be realized by means of bending beam sensors, which may be attached at individual locations respectively compartments of a filling device, for example in a matrix-shaped way. A pressure measuring device of the detector device may measure for example piezoelectrically or by means of an electrical capacity measurement, whether a merchandise element is present at a specific location or not, for example in a specific compartment, of a filling device. Such a pressure measuring device may be embodied for example similar as in a touch pad. Accordingly, it is also possible to form (or embody) the detector device as paired detector devices having one component on a merchandise element and another component configured associatedly at a filling device that accommodates the merchandise element. For example, a transponder, for example an RFID tag, may be mounted on a merchandise element and an RFID tag reader on the filling device. Alternatively, also a magnet label may be mounted at a merchandise element and an according magnetic field detector at the filling device.

According to an exemplary embodiment, the control device may be configured to compare the determined current stock with a respective predetermined, or for example predetermined at user-side, nominal stock (or target stock) and to trigger a predetermined event, if the determined current stock deviates from the predetermined nominal stock by at least a predetermined or specified threshold value. According to an embodiment, the control device may determine for specific filling devices individually or for the filling devices in their totality, whether their respective stock has fallen below a critical value. Then, an event may be triggered, which relates to this specific filling device.

On the contrary, according to another embodiment, a total amount of a specific type of merchandise elements may be determined in the total inventory management system, i.e. integrated over some or all of the filling devices. The threshold analysis may then be performed based on this group of filling devices and may trigger an event only, if a total stock in this group of filling devices falls below the critical value. Alternatively, an event may also be triggered, if a threshold value is exceeded. In the latter case, for example, a re-order stop may be triggered (for example when the inventory exceeds a critical upper value).

According to an exemplary embodiment, the predetermined event may represent the triggering of a re-order (or re-ordering) of particular merchandise elements for an at least partial re-filling of an associated filling device. Thus, a re-order may be triggered in the case of an according result of the threshold value analysis, in order to increase again a stock of merchandise elements that has fallen below a critical value. Such a re-order may be performed in relation to individual filling devices, for example if different filling devices are located at different stock locations and a specified merchandise element is no longer available in sufficient amount at a specified stock location (for example a subsidiary (or chain store)). It is possible, however, to trigger a re-order integrated (or summed) over a plurality of filling devices.

According to an exemplary embodiment, the control device may be configured to trigger the re-order by means of transmitting an electronic communication message (or signalling) to a re-ordering device, which is coupled capably-for-communication (for example a computer, which is coupled with the environment via a network, such as the public Internet in a capabe-for-communication way). Thus, the re-order may be triggered fully automatedly or automatically, if the threshold value analysis leads the control device to a corresponding result. For this purpose, an order may be performed over an electronic communications network, for example over the internet, an intranet, a mobile communications network or the like. Not only the inventory (or stock) analysis, but also the organization of the re-ordering system may thereby be performed substantially in real-time and robustly against errors.

According to an exemplary embodiment, the control device may be configured to select, for the re-ordering, a re-ordering device to be selected from a group of plural re-ordering devices on the basis of at least one data-base-based criterion (i.e. a criterion, which may be applied by means of data, that are stored in a data base, concerning different re-ordering devices). In the course of the organization of a re-order, the control device may selectively access different re-ordering devices, i.e. for example computers of suppliers or branch offices, which computers are coupled capably-for-communication. In this way, it can be ensured that a re-order can be performed successfully even if a particular re-ordering device is not reachable (for example in the case of a disturbance of the communication network) or not capable to deliver.

According to an exemplary embodiment, the data-based-criterion may be selected from a group, which consists of: cost data, delivery capacity data and data relating to the distance between the re-ordering device and the filling device to be re-filled, which data are assigned to a respective re-ordering device. For example, the control device may select the most cost-efficient re-ordering device in the selection of a re-ordering device. For this purpose, one may resort to the cost data relating to the merchandise elements, which (cost data) are stored in a data base of the control device. Alternatively, a current cost (or price) may also be requested over the communication network from the individual re-order devices prior to the performing of a re-order, and a re-order decision may be taken on the basis of the transmitted data. Alternatively or in addition, the deliverability respectively the delivery time may be accounted for, which can be taken by the control device for the individual re-ordering devices also from a data base or requested over a communications network. Also, the distance of a re-ordering device from the location of the filling device, which is to be loaded with the merchandise elements to be re-ordered, may be accounted for. Thereby, delivery paths may be kept short and thus, the re-order may be performed resource-savingly and cost-efficiently.

According to an exemplary embodiment, it may also be possible to send a merchandise element from one storage facility (for example a subsidiary) to another storage facility (respectively to trigger an according transfer in the sense of a system control) or to send clients from one storage facility to another storage facility (respectively to trigger an according transfer in the sense of a system control).

According to an exemplary embodiment, the control device may be configured to determine (or ascertain) the threshold value for a respective filling device and/or at least one associated merchandise element on the basis of a historical development of the associated inventory (or stock of goods). The term “historical development of the stock” may be understood such that the development of the stock in the past, for example the magnitude of the degrees of the stock in respect of a particular merchandise element, is taken into account in the re-order. If a previously known period, namely a delivery period, exists between the triggering of the re-order and the arrival of the re-ordered merchandise elements, and it is known from the historical data, with which rate of sale the merchandise elements that are still available are withdrawn presumably from the filling device in the near future, a larger amount of merchandise elements may be re-ordered, in order to ensure a complete filling (or complete loading) of the filling device just at the arrival of the re-order or to cover the requirement (or demand) for a predetermined period of time.

According to an exemplary embodiment, the predetermined event may be the triggering of a message (or signalling), for example comprising a message (or signalling) of the determined stock or a message in respect of a difference to a threshold value of the inventory. Alternatively to the automatic triggering of a re-order, the control device may thus, in the case of a corresponding result of the threshold value analysis, notify (or signal) this also to a human operator, so that the operator may then trigger an according event, for example a re-order. Thus, the re-order decision of a human operator may occur on the basis of objective criteria of the result of the networked detection of the inventory (or stock of goods). Alternatively, it is also possible, that an operating person may selectively accept, refuse or modify a re-order strategy proposed by the control device.

According to an exemplary embodiment, at least some of the detector devices may be embodied as a flat sensor, particularly as a sensor plate or a sensor foil, which is shaped and dimensioned fittingly to (or with) a merchandise element or a part thereof and/or fittingly to a merchandise reception area of an associated filling device or a portion thereof, and which is configured to generate according to sensor data whence at least one merchandise element bears on the flat sensor. Such a flat sensor may be tailored to a geometry of the filling device and may just cover for example a storage area for merchandise elements. Thus, a simple arming or also retrofitting (or upgrading) of filling devices with a detector device in the form of the flat sensor is enabled. If the flat sensor is formed (or embodied) as a sensor foil, a flexible tailoring of the sensor foil to the available dimension (or size) of a merchandise reception area of a filling device is also possible. The sensor foil may be embodied flexibly or elastically, in order to be capable to adapt itself to a surface topology of the merchandise reception area of a filling device.

According to an exemplary embodiment, the flat sensor may comprise a plurality of sensor elements, which are arranged at predetermined positions (or spots) thereat and/or therein and/or thereupon and with which spaced-resolved sensor data can be generated. For example, the individual sensor elements may be arranged side by side, arranged in a ring-like manner around each other, or arranged in lines and columns, i.e. matrix-shaped. Thus, not only the information can be measured, whether a merchandise element is provided at the filling device, but also at which position (or spot) of the filling device a merchandise element is provided, and preferably with which weight (in order to calculate a fill level). This may for example simplify a robot-controlled refilling of the filling device, because then a robot can be informed at which position a merchandise element to be refilled is to be arranged (or integrated), respectively from which position a merchandise element that is to be removed from the inventory can be removed by the filling device.

According to an exemplary embodiment, the sensor elements may be piezoelectric and/or capacitive and/or ohmic sensor elements. A piezoelectric sensor element may rely on the fact that piezoelectric materials [that are used] as sensor elements output an electrical signal, which is indicative for the pressure exerted by the force due to gravity (or weight force) of a merchandise element. In capacitive sensor elements, a change of the distance between two condenser platelets may be effected caused by the force due to gravity of a merchandise element, so that the presence of a merchandise element is measurable capacitively. Alternatively, a capacitive sensor element may also measure the change of a stray field (or scatter field), whence the dielectric coefficient is changed locally by the presence or absence of merchandise elements. The measurement principle of ohmic sensor elements may rely for example on a change of the value of the ohmic resistance, [which occurs] when a merchandise element is added or removed. An ohmic sensor resistance may for example be influenced in a characteristic way by applying a pressure due to a merchandise element. Alternatively, other types of sensor elements may be possible, for example an arrangement of pressure pads for a space-resolved determining of the presence of merchandise elements, and optionally the determining of their weight.

According to an exemplary embodiment, the control device may comprise a data base and may be configured to store in the data base the determined current stock of at least some of the merchandise elements, particularly broken down to associated filling devices, and/or of filling devices. The data base of the control device, which may be installed in an electronic mass storage, such as for example a hard disk, may thus render inventories that exist at particular points in time. Thereby, according to an embodiment, a total stock of merchandise elements may be stored in the data base, so that for individual merchandise elements the inventory, which exists currently or at a past point in time, is retrievable. According to another embodiment, however, it may also be possible to gather from the data base the associated inventories for individual or all filling devices, because also these data can be derived from the transmitted sensor information and stored.

According to an exemplary embodiment, the inventory management system may comprise a portable user equipment, which is coupled or couplable with the control device capably-for-communication, particularly in order to transmit control commands to the control device and/or to receive information that is indicative for the determined stock from the control device. Such portable user equipment may for example be a smartphone, which may be coupled with the control device capably-for-communication via a communications network, for example a mobile communications network or the internet. Thus, it may be possible for an operator to recall the current stock or to control the system such that a particular event is triggered, for example an order or a re-order, even from a remote location. Also, the availability of merchandise elements may be requested “on the go”, also resolved for (or broken down to) individual locations of filling devices.

According to an exemplary embodiment, at least some of the filling devices and/or at least some of the merchandise elements may have a position data detection device, which is configured to recognize (or measure) information that is indicative for the current location of the respective filling device and/or the respective merchandise element, which information can be transmitted to the control device. For example, a GPS receiver may be present as a position detection device at the individual filling devices or merchandise elements, such that a tracking of the movement profile of such filling devices or merchandise elements is possible. Advantageously, the position information of a respective filling device or a respective merchandise element may be transmitted to the control device via (or through) the same very communication interface, which also transmits the sensor information to the detector device. Thus, the data volume to be transmitted and the effort for the coupling in a capable-for-communication way between the filling devices respectively the merchandise elements on one hand side and the control device on the other hand side, may be kept minor. A stock of merchandise elements respectively a stock of filling devices may thus also be monitored space-resolved.

According to an exemplary embodiment, at least some of the sensor devices may be coupled with the control device capably-for-communication, particularly wirelessly or wire-connectedly. The communication may be performed for example by means of Bluetooth, WLAN, an intranet, the public internet or via a wire-connected or mobile telecommunications network.

According to an exemplary embodiment, different filling devices and/or different merchandise elements may be decoupled from each other capably-for-communication (or decoupled in respect of the capability to communicate) or may be coupled with each other capably-for-communication. Thus, according to an embodiment, autonomous filling devices respectively merchandise elements may be provided, which may work completely independently from each other and which have to be in an exchange of communication only with the control device. Alternatively, even a communication between merchandise elements respectively filling devices may be possible in order to refine (or improve) the capacity (or performance) of the system and to increase the security of the communication in the case of a system break-down.

According to an exemplary embodiment, at least some of the filling devices may comprise filling sub-devices, which may be addable to a respective filling device individually or which are removable therefrom, and from which each one may receive a portion (or some) of the merchandise elements of the respective filling device. The detector devices and/or further detector devices of the inventory management system, which may be optionally provided at the filling sub-devices, may be configured to detect sensor data, which are indicative for a fill state of at least some of the filling sub-devices with the merchandise elements. The control device may optionally be configured to determine a current stock of at least some of the filling sub-devices on the basis of the sensor data. For example, a filling device may be formed (or embodied) as a goods cupboard having a plurality of shelves, wherein one or plural crates may be arranged in each shelf as a filling sub-device respectively intermediate filling device of first order, or may be missing totally or partially. In each of the crates, plural boxes may be arranged as filling sub-devices of second order, of which each one may contain a plurality of merchandise elements. The inventory management system may be configured to monitor the presence respectively absence (or missing) of merchandise elements in each fill level (or fill plane) (respectively in each order). For example, it may be possible to monitor time-resolved and/or space-resolved in a sensor-based way, how many merchandise elements may be present or are missing in individual filling sub-devices of second order, in individual filling sub-devices of first order respectively in superordinate (or higher-ranking) filling devices, and/or at which locations the individual entities are located at a particular point in time. Thus, a hierarchical arrangement of filling devices and of one or a plurality of levels respectively hierarchies of filling sub-devices may be possible, which may be mapped from a physical structure consisting of filling devices, filling sub-devices and merchandise elements to a logical or virtual structure in the data base of the control device, optionally with the aid of position data that have also been measured, even with spatial resolution.

### DETAILED DESCRIPTION OF EXEMPLARY EMBODIMENTS

Further exemplary embodiments of the present invention are described in the following with reference to the following drawings.

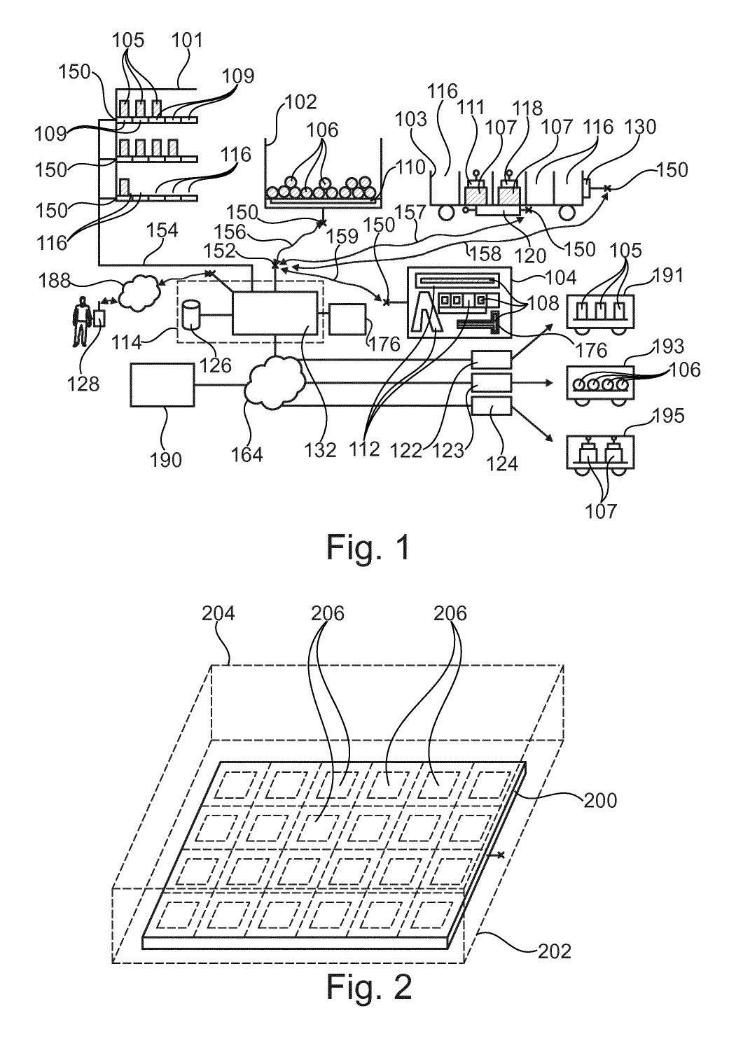

FIG. 1 shows an inventory management system according to an exemplary embodiment of the invention.

FIG. 2 shows a sensor foil, arranged in a filling device, for an inventory management system according to an exemplary embodiment of the invention.

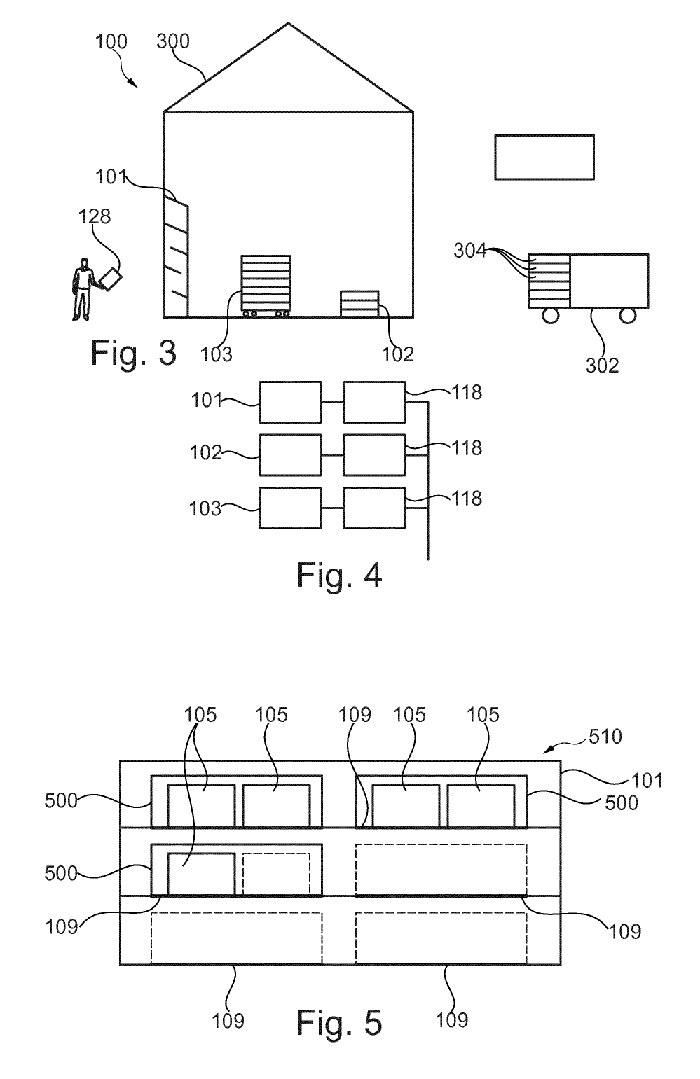

FIG. 3 shows a decentralized arrangement of filling devices and merchandise elements of an inventory management system according to an exemplary embodiment of the invention.

FIG. 4 shows a coupling between merchandise elements and filling devices by means of RFID tags.

FIG. 5 illustrates a hierarchical structure consisting of merchandise elements, filling sub-devices and a filling device of an inventory management system according to an exemplary embodiment of the invention.

The same or similar components are provided with in different figures the same reference numbers.

Before exemplary embodiments of the invention are described with reference to the figures, some general aspects of the invention shall still be explained:

Traditionally, the triggering of re-orders in a merchandise planning and control system (or enterprise resource planning (ERP) system) is difficult or complex, because the measurement (or determination) of an inventory (or stock of goods) for a meaningful re-order decision is time- and labour-intensive.

According to an exemplary embodiment of the invention, there may be provided an intelligent merchandise planning and control management system, in which the triggering of re-orders in a complex merchandise planning and control management system (for example a workshop equipment system comprising workshop trolleys, cases, shelves and boxes) is designed (or configured) simpler and more efficient (or cost-efficient). Such a merchandise planning and control management system may account for both stationary and mobile merchandise elements and filling devices (for example vehicle equipment), for example on construction sites or in the service on the spot.

Detector devices, in particular comprising a measuring unit (for example an optional measurement device such as a camera and/or a weight measuring device) may determine the presence or absence of merchandise elements (for example tools) in filling devices (for example a shelf, a case, a cupboard with shelves, cupboards with drawers or workshop trolleys) as system components of the merchandise planning and control management system, and notify (or signal) these to a central control device, which recognizes (or determines) the fill level respectively the presence/absence of merchandise elements at a particular storage location. For example, photo-sensors may recognize whether a packaging of a merchandise element is present or not respectively whether a photocell receives light in the absence of a merchandise element or receives no light in the presence of a merchandise element at a filling device. In each filling device, specific merchandise elements (for example tools) may be recognized, and re-order processes can be triggered automatically or semi-automatically as required.

According to an exemplary embodiment, there may provided a merchandise planning and control management system, which may comprise, as system components, filling devices (for example shelves with shelf compartments, cases with case inlays, workshop trolleys with workshop trolley inlays, storage boxes with bulk materials, cupboards having drawers with corresponding inlays and other apportionment possibilities respectively vehicle equipment, in particular with shelves in the vehicle). These filling devices or system components may be filled with merchandise elements (for example cardboard boxes with bulk goods, aerosol cans, tapes, cases, canisters or barrels, tools and tool components, screwdrivers, mounting tools, hammers, screw-wrenches and ring wrenches as well as electronic tools and machines, usable and expandable materials, etc.).

The filling devices or system components may contain for example standardized and individualized receiving devices respectively compartments for the merchandise elements. According to an exemplary embodiment, a detector device or measurement unit may be assigned to all of (or each one of) the compartments or entries, preferably the same for all (or each one). However, it may also be possible to provide one measurement unit for plural storage locations on one or plural shelves (levels), for example subject to operation of camera-equipped robots. These [measurement units] may determine the presence of merchandise elements or complex packaging units of merchandise elements, particularly also the amount of merchandise elements that are present. The detector devices respectively measurement units may transmit the measured values to the control device [operating] as a centralized storage administration.

In the control device, the filling devices or system components may be initially deposited (or lodged) with their respective contents consisting of merchandise elements, preferably with a position information. Changes of the stock (or inventory) may be measured by means of the detector devices and transmitted to the control device [operating] as an administration center. Thus, the stock portfolio (or inventory) in all (or in each one of) the system components and thus in the complete merchandise planning and control management system may be available at each point in time, in particular space-resolved.

The detector devices may comprise a weight measuring device, for example in the form of a scales, an optical recognition (or measurement) device, for example in the form of a camera, or an RFID device. A sensor scales, a weighing cell having bending beams, bar code scanners, pressure sensors, photo-electric barriers, camera-based code readers, piezo elements, etc. may also be possible. The transmission of signals from the detector devices to the central control device may be performed for example by means of Bluetooth or WLAN respectively LAN or via another telecommunications connection (or link). The control device may contain information in relation to each merchandise element, [stored] in an associated data base, for example product descriptions, product data sheets, admissions (or permissions), application videos, application descriptions, etc.

The control device may not only trigger orders, but may also manage them (in particular on the basis of the inventory (or stock) measurement). This may be advantageous in order to avoid that missing merchandise elements are not re-ordered multiple times. Orders and shopping baskets may be prepared respectively revised by the user, i.e. proposed re-ordering processes may be accepted, changed or rejected by an operator. The current stock may be checked and order processes may be triggered via the control device even location-independently. The control device may be retrievable or operable for example also via an app (or application for a mobile device). Beside the mentioned article information, also [other] information may be transmitted via the central administration or control device on the part of a supplier (for example client-specific offers, virtual sample cards, sample inspections (or selections of samples), etc.). In the control device, all (or each one of) the merchandise elements may be catalogued for example by pictures and, if necessary, with dimensions, weight, etc. in addition to an article number and a bar code. In the control device, stock articles may be administered and managed (or kept in record) on one hand side and on the other hand side all the articles that have been purchased by a client may be listed. This may be supplemented at each acquisition (or buy) accordingly, so that a client-individual online-shop may be provided.

According to an embodiment, the storage facility (or warehouse) may be a distinct stock facility that is being managed. The registration of the incoming goods and outgoing goods of merchandise elements may be accomplished there.

According to another embodiment, the storage facility may be a storage facility, from which clients are served. Client data may then advantageously be deposited in the control device, preferably with a client-related purchase history.

According to still another embodiment, the storage facilities may be those at the customer location, which are refilled (as required).

In this respect, merchandise elements that have been purchased, selling baskets and the contents of system components respectively filling devices may be listed. The control device may manage (or keep in record) cost centers, which may be assigned to individual filling devices, and may relate withdrawals and orders as well as transactions of merchandise elements, for example via a bar code, accordingly. Data, such as for example test and service intervals, reparation management (or reparation administration), etc., may be provided to the control device [operating] as a centralized administration.

The information may be made available by the control device to other (particularly mobile) end devices, for example a smartphone, a laptop, etc. The operators of such mobile end devices may be the staff members or clients of the merchandise planning and control management system. By means of such end devices, it may be possible that staff members of the merchandise planning and control management system may download information relating to products (or goods) and may thus order merchandise elements or may apprehend (or review) admissions (or permissions) of the merchandise elements. By means of such end devices, staff of the merchandise planning and control management system may further create offers and invoices relating to material for tasks to be executed, optionally also subject to the introduction of an electronic signature, may take site measurements of construction sites, may take and store project-related data, in particular by utilizing the same end device.

Suppliers of merchandise elements for the merchandise planning and control management system may explain merchandise (or goods) tools and/or tools components to the staff member of the merchandise planning and control management system on the basis of information deposited in the control device and/or may order for them. The information that may be deposited in the control device of the merchandise planning and control management system may be stored locally or may be retrieved from a supplier for the merchandise planning and control management system respectively may be provided merely in this system. Since the occupancy of the filling device may be deposited in the control device, each re-order can be assigned uniquely to the filling device, for which the re-order intended. Supportively, the storage location for a merchandise element may provide a signal, for example an optical signal of a lamp that lights up, so that the merchandise can be sorted in (or incorporated) quickly at the right location. The information that may be required for this may be indicated on the order (or order form), the invoice, the delivery note and/or the order confirmation. The filling devices may respectively (or may each) have an antenna or another communications interface for transmitting the information of the detector devices to the control device. A two-dimensional or three-dimensional representation of the filling devices and their contents may be deposited in the control device, in order to make these available to the users of the merchandise planning and control management system (also at end devices, as required).

The filling devices may be equipped with GPS transmitters, so that an overview is available, where which filling device (for example, where and which vehicle) with which merchandise elements (for example with which tools) is currently located. In cases of workshops having plural subsidiaries, an overview over workshop trolleys with the associated tools may thus be available. The merchandise elements may be provided with an RFID tag, for example in order to assign to a staff member the merchandise elements and/or filling devices that are taken along by him upon leaving a workshop. The assignment to the staff member may thereby be effected for example by means of a staff identification badge having an RFID tag or another identification characteristic. The loading of the filling devices and the administering in the control device associated therewith may be carried out by a supplier and/or by a staff member of the merchandise planning and control management system.

The inventory (or stock in hand) may be retrieved for example periodically (for example each morning or each evening), but also individually in response to a user request. The inventory (or stock) request may be effected continuously or at predetermined points in time. Well-defined times may be possible for the triggering of an order process (for example, all the merchandise elements that are not sorted in the filling devices again (that are not recaptured again) until 9 o'clock p.m. are re-ordered).

By means of such a system, it may be possible for the operator of a S merchandise planning and control management system to always have available the inventory (or stock) of a plurality of subsidiaries, storage facilities, containers, etc. An order may be triggered at the nearest point of sale via an app or the like, such that the merchandise elements are receivable via short delivery paths.

Exemplary embodiments may have the advantage, that a complete inventory of stock at hand (or stock portfolio) may be enabled across all the filling devices down to the level of merchandise elements. The stock portfolio may be retrievable independently from time and location. An automated signalling or ordering of stock shortfalls is possible. Thus, a clearly arranged overview over (or on) the ordering processes and the tracing (or tracking) of delivery processes may be enabled even for a complex merchandise planning and control management system.

An inventory management system 100 according to an exemplary embodiment of the invention is described in the following with reference to FIG. 1.

The inventory management system 100 contains a plurality of filling devices 101 to 104, which are to be filled with different merchandise elements 105 to 108, and which are respectively partially filled with merchandise elements 105 to 108, as shown in FIG. 1.

A first filling device 101 is embodied as a goods cabinet (or cupboard), which has a plurality of shelf compartments, of which each one may be filled with up to five first merchandise elements 105. In fact, in a first shelf compartment, there are provided three, in a second shelf compartment there are provided four and in a third shelf compartment there is provided one first merchandise element 105. A second filling device 101 is formed as a bulk goods box, in which bulk goods (or loose material) is filled in the form of second merchandise elements 106. A third filling device 103 has five compartments 116, wherein in each of the mutually spatially separated compartments 116, a third merchandise element 107 may be accommodated. In fact, only two of the five illustrated compartments 116 that are currently filled with respectively one third merchandise element 107. A tool case is provided as a fourth filling device 104, which has respective receiving recesses, which are shaped and dimensioned such that in each of the receiving recesses there may be accommodated precisely one associated fourth merchandise element 108 in the form of a correspondingly shaped tool.

Detector devices 109 to 112 are provided on (or at) the filling devices 101 to 104 respectively on (or at) the merchandise elements 105 to 108, which detector devices generate sensor data that are indicative for the fill state of the respective filling devices 101 to 104 with the corresponding merchandise elements 105 to 108, and transmit them (the sensor data) via communication interfaces 150 to associated communication interfaces 152 of a centralized control device 114.

Pressure pad sensors are integrated in the merchandise reception shelves of the individual shelf compartments of the first filling device 101 as first detector devices 109, which create an according pressure signal upon the application of a force due to gravity of a respective first merchandise element 105 consequent to the presence thereof. Thus, the presence or absence of the respective merchandise element 105 may be measured sensorily (or by means of a sensor) in a space-resolved way and may be transmitted via a, in this case wire-connected, communications link 154 of the control device 114.

In the second filling device 102, there is provided, as a second detector device 110, a scales device for measuring the weight of the bulk goods as the second merchandise element 106. The according result may be transmitted via a (in this case wireless) communications link 156 to the communications interface 152 of the control device 114 in a wireless way.

RFID tags 118 [functioning] as the third detector device 111 are mounted on (or at) the third merchandise elements 107, which RFID tags may exchange an according signal with an RFID tag reading device 120 mounted at the third filling device 103, when the distance between the respective RFID tag 118 and the RFID reading device 120 is sufficiently short. This is so precisely, if a respective compartment 116 is filled with a third merchandise element 107. In this way, the RFID reading device 120 can determine how many third merchandise elements 107 are present in the compartments 116 and at which positions, i.e. in which ones of the compartments 116 these third merchandise elements 107 are located. The according result can be transmitted wirelessly via a, in this case wireless, communications link 157 to a communications interface 152 of the control device 114.

In the receiving recesses of the fourth filling device 104, there are accommodated respective piezoelectric pressure sensors [operating] as the fourth detector devices 112, which are capable to detect the presence of respective tool elements in the receiving recesses and capable to transmit this wirelessly via a, in this case wireless, communications link 159 to the communications interface 152 of the control device 114.

The control device 114 is configured to determine a current stock of the filling devices 101 to 104 with merchandise elements 105 to 108 on the basis of the sensor data. For this purpose, a processor 132 of the control device 114 performs according algorithmic calculations and thereby resorts back to software and data stocks, which are stored in a data base 126 of the control device 114. The data base 126 is embodied as an electronic mass storage, for example a hard disk.

If the control device 114 determines that an actual stock of merchandise elements 105 to 108 in a respective filling device 101 to 104 has fallen below a predetermined threshold value, this then triggers an automatic re-order process. For this purpose, the control device 114 transmits a corresponding communications message via a communications network 164, for example the public Internet, to one of a plurality of re-ordering devices 122 to 124. The latter are embodied for example as computers of suppliers, who carry the corresponding merchandise elements 101 to 104 in their line of goods and are able to refill these, or are secondary storage facilities of the merchandise planning and control management system, for example a spatially separated subsidiary. FIG. 1 shows by way of example that the individual re-ordering devices 122 to 124 have specific merchandise elements 105 to 107 on stock at the respective filling devices 191, 193, 195. The selection, which particular one of the re-ordering devices 122 to 124 is to be selected for a particular re-order process, may be effected on the basis of their costs (or prices), assortments, delivery times and/or spatial distances between an associated filling device 101 to 104 and the re-ordering device 122 to 124. Corresponding data are deposited in the data base 126 and may be requested from the re-ordering devices 122 to 124 via the communications network 164 on the part of the control device 114. Alternatively, the current inventory may be displayed (or indicated) by means of the control device 114 on a display device of an input/output unit 176 to an operator, respectively a proposal may be provided for a re-order, such that the operator is able to effect the proposed re-order via the input/output unit 176, is able to reject it or is able to effect it in a modified way.

A user may also communicate bi-directionally via a portable user equipment 128 with the control device 114, in order to be able to operate the latter from a remote location or in order to be capable to retrieve the data from there. For this purpose, a communications network 188 may be employed, which may be the same as the communications network 164 or may be another one (for example a telecommunications network).

It can also be seen in FIG. 1 that the third filling device 103 is equipped with a GPS receiver as a position measurement (or recognition) device 130, such that, by the transmittal of the sensor data between the communication interfaces 150, 152, also the current position information relating to the current whereabouts of the third filling device 103, in this case a mobile workshop trolley or a vehicle of a field staff member, can be communicated. By these means, the merchandise planning and control management system 100 according to FIG. 1 can be managed (or administered) in real-time also in respect of the current whereabouts of the filling device 103 and the assigned merchandise elements 107.

Via the communications network 164, even a client of the merchandise management system may access the data in the data base 126 via a client computer 190 respectively may communicate uni- or bi-directionally with the control device 114, insofar as the control device 114 grants the corresponding authorization for accessing the corresponding data to the client computer 190.

FIG. 2 shows a two-dimensional sensor foil 200 in a drawer [operating] as a filling device 204. Thereby, the accordingly tailored sensor foil 200 lines a bottom 202 of the drawer 204. It can be taken from FIG. 2 that the sensor foil 200 is provided with a two-dimensional, matrix-like arrangement of sensor elements 206, for example piezoelectric sensors, capacitive sensors or pressure pad sensors. Thus, the drawer 204 can be retrofitted in order to be integrated in the merchandise planning and control management system 100 according to FIG. 1. For this purpose, the sensor foil 200 has turned out to be particularly suitable.

FIG. 3 shows again the high flexibility of a merchandise planning and control management system 100 according to the invention. Some of the filling devices 101 to 103 may be accommodated in a house 300, such as for example a storage building. Another filling device 302 [embodied] in the form of a mobile trolley, which is equipped with a tool set as (or representing) the merchandise elements 304, may also be integrated in the merchandise planning and control management system 100 “on the go” (or in a mobile way).

FIG. 4 shows that different filling devices 101 to 103, for example a case, an inlay or a machine, may be provided with RFID tags 108, for which the corresponding data may be deposited in a data base 126 of the control device 114 (for example a server) (which may be advantageous for the addressing of the same (the data).

FIG. 5 illustrates a hierarchical physical structure 510 consisting of merchandise elements 105, filling sub-devices 500 and a filling device 101 of a merchandise planning and control management system 100 according to an exemplary embodiment of the invention. Data, which are associated with the physical structure 510 and with many other corresponding physical structures of the inventory management system 100, may be stored (or deposited) in the data base 126 of the control device 114 in the form of a data set, which represents a conceptual (or abstract) mapping of the physical structure 510 as (or onto) a virtual structure. If the physical structure 510 changes (for example because merchandise elements 105 are removed from the filling device 101), then the corresponding data set in the data base 126 can be updated accordingly and displayed to an operator.

In the illustrated embodiment, the filling device 101 is shown as a goods cabinet (or cupboard) having three shelves, each of which constitute two receiving spaces for receiving goods crates (or goods boxes) as (or representing) filling sub-devices 500 of the filling device 101. Each receiving space is equipped with an associated detector device 109, for example in the form of a weight sensor. In the example shown, three of the six receiving spaces are filled with filling sub-devices 500, not so are the three others (indicated in a dashed fashion). Each of the filling sub-devices 500 in turn provides space for receiving two merchandise elements 105. Two of the three filling sub-devices 500 are filled (or loaded) with two merchandise elements 105, the third filling sub-device 500 is filled with only one merchandise element 105 (indicated in a dashed way).

By means of the detector devices 109, it is possible to determine at each point in time, in a hierarchy-resolved way, i.e. separately for the filling sub-devices 500 and the filling device 101, how many merchandise elements 105 are located and where. Thus, the inventory management system 100 according to the illustrated embodiment example can incorporate (or include) different layers of the filling (or loading) in the administration.

According to another exemplary embodiment, the process flow for the filling can be controlled (or operated) as follows: When the merchandise (or goods) arrive at the client, the client scans the goods. A storage location, at which the goods is to lie (or is to be stored) in accordance with the intended use, lights up. Thus, the client can sort in the goods at the indicated location speedily.

Additionally, it shall be noted that the term “comprising” or “having” does not exclude other elements or steps, and that the expression “a” or “an” does not exclude a plurality. Furthermore, it shall be pointed out that features or steps, which have been described with reference to one of the above embodiment examples, may also be used in combination with other features or steps of other embodiment examples described above. It should be noted also that reference numerals in the claims shall not be construed as limiting the scope of the claims.

1.-23. (canceled)

24. Inventory management system, comprising:
a plurality of filling devices, which are to be filled with merchandise elements and which contain mobile filling devices;
a plurality of merchandise elements in and/or at the filling devices;
detector devices, which are assigned to the filling devices and/or merchandise elements and which are for detecting sensor data that are indicative for a fill state of at least some of the filling devices with the merchandise elements; and
a control device, which is configured to determine a current stock of at least some of the filling devices and/or of at least some of the merchandise elements, in particular in and/or at the filling devices, based on the sensor data.

25. Inventory management system according to claim 24, wherein the filling devices are selected from a group, which consists of: a goods shelf, a goods cupboard, a canister, a goods drawer, a container for bulk goods, a goods box, a delivery vehicle, an assembly line, a tool trolley, a mobile workshop, a workbench and a tool case.

26. Inventory management system according to claim 24, wherein the merchandise elements are selected from a group, which consists of: not packed merchandise elements, packed merchandise elements, bulk goods, fluid, a canister, a packing case, a box, a mobile workshop equipment, a workbench equipment, a tool set, a vehicle equipment and a consumer product equipment.

27. Inventory management system according to claim 24, wherein the detector devices are selected from a group, which consists of:
at least one optical measuring device for measuring optical data of at least one merchandise element and/or of compartments of a respective filling device, which compartments are to be filled with one or a plurality of merchandise elements;
a weight measuring device for measuring a weight of at least one merchandise element and/or in a compartment of a respective filling device, which compartment is to be filled with one or a plurality of merchandise elements;
an electrical sensor for measuring an electrical indicator, which indicator is dependent from a fill state, of at least one merchandise element and/or in a compartment of a respective filling device, which compartment is to be filled with one or a plurality of merchandise elements;
a pressure measuring device for measuring a pressure of at least one merchandise element and/or in a compartment of a respective filling device, which compartment is to be filled with one or a plurality of merchandise elements;
a scanner for determining scan data of one or a plurality of merchandise elements, which are arranged in a respective filling device, and a combination of a transponder, in particular an RFID tag, at a respective merchandise element and an associated transponder reading device at an associated filling device.

28. Inventory management system according to claim 24, wherein the control device is configured to compare the determined current stock with a respective predetermined nominal stock and to trigger a predetermined event, if the determined current stock deviates from the predetermined nominal stock by at least a preset or determined threshold value.

29. Inventory management system according to claim 28, wherein the predetermined event represents the triggering of a re-order of particular merchandise elements for an at least partial re-filling of the associated filling device.

30. Inventory management system according to claim 29,
wherein the control device is configured to trigger the re-order by means of transmitting an electronic communication message to a re-ordering device that is coupled capably-for-communication, and/or
wherein the control device is configured to select a re-ordering device to be chosen from a group of a plurality of re-ordering devices for the re-order on the basis of at least one data base-supported criterion, wherein in particular the at least one data base-supported criterion is selected from a group, which consists of: cost data, delivery capacity data and data relating to the distance between the re-ordering device and the filling device to be re-filled, which data are assigned to a respective re-ordering device.

31. Inventory management system according to claim 28, wherein the control device is configured to determine the threshold value for a respective filling device and/or at least one merchandise element corresponding to a respective filling device on the basis of a historical development of the inventory assigned to the merchandise element.

32. Inventory management system according to claim 28, wherein the predetermined event represents the triggering of a message, for example comprising a message of the determined inventory or a message relating to a difference to a threshold value of the inventory to an operator.

33. Inventory management system according to claim 24, wherein at least some of the detector devices are embodied as a flat sensor, in particular as a sensor plate or a sensor foil, which sensor is shaped and sized fittingly to a merchandise element or a portion thereof and/or fittingly to a goods reception zone of an associated filling device or a portion thereof, and which is configured to generate sensor data that are indicative for a resting of at least one merchandise element on the flat sensor.

34. Inventory management system according to claim 33, wherein the flat sensor has a plurality of sensor elements, which are located at predetermined positions thereat and/or therein and/or thereon and by which space-resolved sensor data can be generated.

35. Inventory management system according to claim 34, wherein the sensor elements are piezoelectric and/or capacitive and/or ohmic sensor elements.

36. Inventory management system according to claim 24, wherein the control device has a data base and is configured to store in the data base the determined current inventory of at least some of the merchandise elements, in particular broken down by assigned filling devices, and/or of the filling devices.

37. Inventory management system according to claim 24, comprising a portable user equipment, which is coupled or couplable capably-for-communication with the control device, in particular so as to transmit control commands to the control device and/or to receive from the control device information that is indicative for the determined inventory.

38. Inventory management system according to claim 24, wherein at least some of the filling devices and/or at least some of the merchandise elements have a position data identification device, in particular a GPS receiver, which is configured to recognize information that is indicative for the current location of the respective filling device and/or the respective merchandise elements, which information is transmittable to the control device.

39. Inventory management system according to claim 24, wherein at least some of the sensor devices are coupled capably-for-communication to the control device for transmitting the sensor data to the control device, in particular wirelessly or wire-connectedly and/or uni-directionally or bi-directionally.

40. Inventory management system according to claim 24, wherein different filling devices and/or different merchandise elements are decoupled capably-for-communication from each other or are coupled capably-for-communication with each other.

41. Inventory management system according to claim 24,
wherein at least some of the filling devices comprise filling sub-devices, which are separately addable to the respective filling device or removable therefrom, and of which each one receives a portion of the merchandise elements of the respective filling device, and
wherein the detector devices and/or further detector devices of the inventory management system, which are provided at the filling sub-devices, are configured to detect sensor data that are indicative for a fill state of at least some of the filling sub-devices with the merchandise elements;
wherein the control device is configured to determine a current stock of at least some of the filling sub-devices based on the sensor data.

42. Method for managing an inventory in a plurality of filling devices, which are filled with and/or to be filled with merchandise elements and which contain mobile filling devices, wherein the method comprises:
detecting sensor data, which are indicative for a fill state of at least some of the filling devices with the merchandise elements by means of detector devices assigned to the filling devices and/or to the merchandise elements; and
determining a current stock of at least some of the filling devices and/or of at least some of the merchandise elements, in particular in and/or at the filling devices, based on the sensor data.

43. Computer-readable storage medium, in which a program for managing an inventory is stored, or
software program for managing an inventory,
wherein the program respectively the software program executes and/or controls the method according to claim 42, when the program is executed by a processor of a control device.
